(19) United States
(12) Patent Application Publication
(10) Pub. No.: US 2012/0160985 A1
(43) Pub. Date: Jun. 28, 2012

(54) Damping bridge

(76) Inventors: Jean-Claude Pollet, Vaux sur Seine (FR); Nicolas Gournes, Breaute (FR); Baptiste Audrezet, Beaupreau (FR); Dominique Comté, Aubergenville (FR)

(21) Appl. No.: 13/391,749

(22) PCT Filed: Aug. 23, 2010
(86) PCT No.: PCT/FR2010/051754

§ 371 Date: Mar. 16, 2012

(30) Foreign Application Priority Data
Aug. 24, 2009 (FR) 0955763

(51) Int. Cl. F16L 55/035; F16F 7/00

(52) U.S. Cl. 248/636

(57) ABSTRACT

The invention relates to a damping bridge (6), characterized in that it includes two substantially parallel diaphragms (8, 9), an arm (7) extending perpendicularly to said diaphragms and connecting said diaphragms to one another, and a structure (10) connecting said diaphragms together over at least a portion of the outer edge thereof.

### TECHNICAL FIELD OF THE INVENTION

The present invention relates to a fastening device. More specifically, the present invention relates to a fastening device for fixing a pipe to a wall or a face, for strongly attenuating the transmission of vibration forces of the pipe normal to the wall or to the face, thus reducing the “structural” noise intensity, while ensuring a solid holding of the pipe. The pipe can be filed with water or with a liquid, which can represent substantial forces parallel to the wall or partition for wide diameters canalizations.

### RELATED PRIOR ART

A fastening device for a pipe typically comprises a collar for holding the pipe, a base connected to the collar and provided to be fixed to a wall, and damping means for damping vibrations transmitted from the pipe to the wall. The goal is to limit the structural noise generated by vibrations transmitted to the wall, and it is therefore possible to call this type of fastening device “acoustic collar”.

Document EP 0 585 543 describes a fastening device having a double collar, which has good damping performances. However, the structure having a double collar involves high costs, difficulties in the assembling, is cumbersome, has a non-esthetic aspect and cannot be realized in a single-material piece.

Document EP 0 666 628 describes a fastening device in which open collars are connected to a base by a flexible bridge and bending elements. This structure does not ensure both good damping and good mechanical strength.

Document WO 2004/074707 describes a fastening device in which the collar is connected to the base by a damping bridge consisting of two deformable rings. The damping bridge can be deformed in all directions, which implies movement of the pipe in all directions. In addition, this device cannot withstand high loads without excessive deformations.

Document EP 1 482 205 describes a vibration damping device comprising a monopiece body and made from an elastomeric material substantially cylindrical and having in its center a hole opening and presenting at each one of its extremities, an annular lip, called respectively an inferior annular lip and an inferior annular lip, each presenting an inwardly curved portion towards the body and facing each other, characterized in that the device comprises a third annular lip being intermediate with a parallelogram transversal section, in that the three lips are adapted to enter in a saturation state when a pressure superior to 10 N is applied on each one of the extremities of the body and when simultaneously, a pressure superior to 50 N is laterally applied on each lip, and in that the opening hole has a rectangular transversal section at each extremity and presents a hollow shape between the two extremities.

This device having incurved lips needs to be made of an elastomeric material and may deform laterally and angularly easily.

Document EP 0 793 432 describes a suspension terminal frame with a three points bridge for transversal laths of a bed base structure. This device cannot absorb vibrations that are perpendicular to the axis of the corresponding device.

Document DE 10 2006 025 055 describes a multidirectional vibration coupling device comprising a segment having a variable fastening device for supporting a force, a body made from a permanent elastic material and two flat rigid discs connected one to another. This device having elastic toric elements easily angularly deforms under deported lateral forces effects and its geometrical shape cannot assure a low axial rigidity and a large axial or angular resistance. In addition, it is difficult to provide this device with only one sole material.

### SUMMARY OF THE INVENTION

A problem that the present invention proposes to solve is to provide a fastening device that does not have at least some of the aforementioned disadvantages of the prior art and which allows to meet the requirements of the aimed field of application. In particular, an object of the invention is to provide a damping bridge which has good damping of vibrations in a perpendicular direction to the wall plan on which it will be fixed while providing good support of the pipe.

The object proposed by the invention is a damping bridge which comprises two membranes, a central rigid arm extending perpendicularly to the membranes and connecting the membranes to one another, and a lateral rigid structure connecting the membranes together over at least a portion of the outer edge thereof, characterized in that the membranes are substantially flat and substantially parallel to each other, distant from each other, and fixed first in said central arm and second, in said structure.

With these features, on the one hand, the vibrations experienced by the arm perpendicular to the membrane meet less effort, because of the deformation reaction of the membranes, and the vibrations are transmitted, attenuated, to the structure, and on the other hand, the plane and parallel membranes, fixed in the central arm and in the structure, are only slightly deformed under loads oriented in a direction perpendicular to the plan of the membranes. Like this, the loads perpendicular to the arm axis (for instance, a pipe installed in a collar fixed on the central arm) will be transmitted without substantial deformation of the damping bridge. Additionally, this feature allows a good support of the pipe.

Indeed, under the action of a deported load acting on the central rigid arm in a direction parallel to the plan of the membranes, this arm acts like a lever which takes support on each of the membranes, where the resulting forces are parallel to the direction of the load and act in the plan of these membranes. These membranes being flat and fixed in the rigid lateral structure, they support substantially well, in traction, the reaction forces caused by the central arm. Because of the lever effect, this device will be more efficient when the membranes are distant from each other. Distance therefore decreases:

a) the reaction forces to which the membranes are subjected;

b) their deformation, as small as they can be; and

c) the deformations of the structure and of the arm, as small as they can be.

The maximal distance between the membranes will be a function of the desired maximum overall dimension of the device.

According to an embodiment, the structure has a cylindrical shape having a generatrix parallel to the arm and a directrix corresponding to an edge of the membranes.

Preferably, said structure has a cylindrical rotating shape, said arm having a cylindrical rotating shape and being coaxial with said structure.

This shape allows very good damping parallel to the central arm while giving a very good mechanical position/hold in all directions perpendicular to the arm.

A variant consists in gutting the flat membrane with elongated radially oriented holes or in replacing the flat membrane by a flat structure consisting in an assembly of radiuses of matter connecting the central arm to the lateral structure, for instance rectilinear or in the shape of sector areas.

According to another embodiment, the structure includes two lateral arms located on either side of the arm, the membranes having a plate shape extending from one of the arms to the other.

Advantageously, the damping bridge is made of a single-material piece.

Preferably, the membranes have a thickness smaller than said arm and said structure.

Thus, the structure and the arm are more rigid than the membranes, even when they are made of the same material. Hence, the membranes deforms when the damping bridge is subjected to vibrations.

The present invention also proposes a fastening device comprising a collar designed to maintain a pipe, a base for fixing to a wall, and a damping bridge as described above connecting the collar to the base.

In a variant, the central arm of the damping bridge is fixed to the wall. This section of the damping bridge fixed to the wall constitutes, in this variant, the base.

Advantageously, the damping bridge, the base and at least part of the collar are made of a single-material piece.

According to another embodiment, the fastening device includes a first stop fixed to the collar and a second stop connected to the base, the first stop and the second stop being able to cooperate to prevent movement of the collar at a distance from the base, with amplitude greater than a given threshold.

### BRIEF DESCRIPTION OF THE DRAWINGS

Further features and advantages of the present disclosure will become apparent from the following detailed description of different embodiments of the invention, given for illustrative and not limitative purposes, taken in combination with the appended drawings. On these drawings:

FIG. 1 is a perspective view, in partial section, of a damping bridge according to a first embodiment, and a fixing base;

FIG. 2 is a sectional view of the damping bridge and of the base of FIG. 1;

FIGS. 3 and 4 are schematic views of two fastening devices including the damping bridge of FIG. 1;

FIG. 5 is a perspective view of a damping bridge according to a second embodiment; and

FIGS. 6 and 7 show, in perspective, two fastening devices including a damping bridge similar to the bridge of FIG. 5.

### DETAILED DESCRIPTION OF EMBODIMENTS OF THE INVENTION

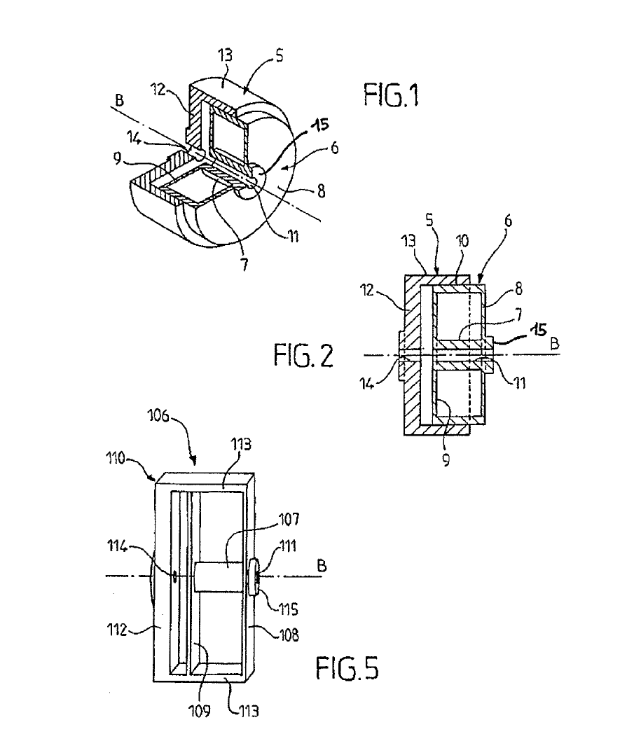

FIGS. 1 and 2 represent a damping bridge 6 according to a first embodiment and a base 5.

The damping bridge 6 comprises a central arm 7, two membranes 8 and 9, flat, parallel and distant from each other, and a lateral structure 10. The membranes are, in their center, fixed in the central arm and, on their periphery, fixed in the lateral structure.

The central arm 7 has a cylindrical rotating shape, having an axis B which passes through a hole 11 arranged to perform a fastening device. The membranes 8 and 9 are two disks parallel to each other, perpendicular to the axis B, centered on the axis B. The central arm 7 accordingly connects the center of the membrane 8 to the center of the membrane 9. The end 15 of the central arm 7 exceeds the disk 8. The structure 10 has a cylindrical rotating shape, also of an axis B, which surrounds the central arm 7. The structure 10 connects the circumferences of the membranes 8 and 9 together. In other words, in each direction perpendicular to the axis B, the structure 10 connects the membranes 8 and 9 on both sides of the central arm 7.

In a variant not shown, the two membranes have a different geometry, for instance, a different diameter. The structure that connects them may have a tapered shape.

The membranes 8 and 9 have a small thickness compared to their perpendicular dimension to the axis B. In addition, the membranes are made of an elastically deformable material, such as metal or thermoplastic material. The structure 10 and the central arm 7 are more rigid than the membranes 8 and 9. For example, if they are made from the same material, they are thicker than the membranes 8 and 9.

The base 5 has a bottom wall 12 through which a central hole 14 is arranged to obtain a fastening device on a wall such that the membranes of the bridge are parallel to the plan of this wall, and a lateral wall 13 in the form of a right cylindrical cylinder. This lateral wall 13 is adjacent to the lateral structure 10, such that the base 5 envelops a section of the damping bridge 7, and more particularly the membrane 9. However, it does not envelop the membrane 8, nor the end 15 of the arm. In FIGS. 1 and 2, the damping bridge 6 is securely fixed to the base 5 through the structure 10. This fastening may be permanent, for example by force fitting, gluing or welding. It can also be controlled so as to adjust or set the distance between the end 15 of the central arm 7 and the bottom wall 12. The adjustment is achieved by sliding the structure 10 in the lateral wall 13 and then holding it up to the desired position by any suitable means (for example, screwing the structure 10 in the lateral wall 13, slots and clamping legs arranged on the wall 13 . . . ).

The damping bridge 6 can connect, to the base 5, an element attached to the end 15 of the central arm 7 while providing two functions. On the one hand, vibrations oriented parallel to the axis B are damped by deformation of the membranes 8 and 9. The base 5 is therefore subjected to limited vibration forces parallel to the axis B. On the other hand, the loads that are perpendicular to the axis B are transmitted to the base 5 without perceptible deformation of the damping bridge 6. Thus, the end 15 of the arm 7 is a good fastening point.

The element attached to the central arm 7 is, for instance, a collar 4, as described below. Of course, the damping bridge 6 can be used in any other application.

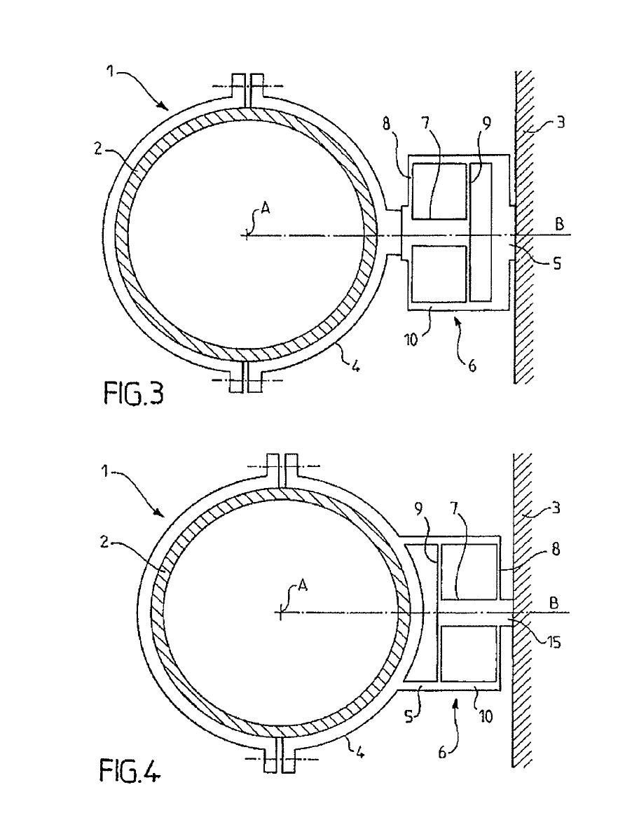

FIG. 3 is a block diagram showing a fastening device 1, for attaching a pipe 2 to a wall 3. The fastening device 1 allows absorbing the vibrations transmitted from the pipe 2 to the wall 3 and thus limits the generated structural noise. Thus, the fastening device 1 can also be called an “acoustic collar”. The wall 3 can be for example a wall, partition or ceiling. The pipe 2 extends along an axis A which is perpendicular to the plane of the figure and parallel to the wall 3.

The fastening device 1 includes a collar 4, the base 5 and the damping bridge 6 of Figures 1 and 2, which are represented in a more schematic manner. The damping bridge 6 connects the collar 4 at/to the base 5. The collar 4 is fixed to the damping bridge 6 for example using a screw (not shown) passing through the hole 11. The base 5 is attached to the wall 3, for example using a screw (not shown) passing through the hole 14.

As explained above, in one embodiment, it is possible to adjust the distance between the end 15 and the bottom wall 12. The distance between the pipe 2 and the wall 3 can thus be adjusted.

In FIG. 3, the collar 4 is shown with two half-rings attached to each other to surround the pipe 2. Alternatively, the collar 4 may present any other configuration to maintain in place the pipe 2. Due to the damping bridge 6, it is possible to significantly tighten the pipe 2 to keep it firmly in place and prevent slippage in the collar 4, this without compromising the acoustic qualities of the fastening device 1. The same fastening device 1 can also be used without tightening the collar 4 on the pipe 2, while maintaining the same acoustic qualities.

The base 5 has a support surface in contact with the wall 3, with which it is attached, for example by screwing, and that allows the damping bridge to be positioned so as to have its membranes parallel to the surface of the wall.

Thus, on the one hand, the membranes 8 and 9 can deform to allow movement of the central arm 7 relative to the base 5, in the direction of the axis B. This displacement involving an elastic deformation has the effect of damping the vibrations of the pipe 2 perpendicular to the wall 3. The forces of vibration transmitted to the wall 3 are low and the generated structural noise is limited.

Typically, for a water discharge line, the amplitude of vibration of the pipe is less than 100 or 200 microns in the frequency range from 50 to 800 Hz and becomes even lower to the highest audible frequencies. These vibrations must be damped as best as possible. The performance of known acoustic collars can be quantified from 30 dBA for the simplest and to 15 to 20 dBA for the top performers. Some measurements have shown that the fastening device 1 can reach a performance of 10 dBA or less. The above values are those of the structural noise obtained in accordance with standard EN 14366.

On the other hand, due to the flat geometry and the disposition of the membranes 8 and 9, which is coupled and parallel, distant and fixed, these can not deform in the direction perpendicular to the axis B. The collar 4 can neither move parallel to the wall 3 nor tilt significantly. The fastening device 1 therefore allows a secure fit of the pipe 2.

The fastening device 1 thus prevents, when the collar 4 is tightly fixed on the pipe 2, the pipe 2 to travel parallel to the wall 3, while allowing and damping vibrations of small amplitude perpendicularly to the wall 3.

FIG. 4 shows a variant of the fastening device 1 of FIG. 3. The same references as in FIG. 1 are used, without any risks of confusion, and a detailed description is unnecessary.

In this embodiment, the base 5 is connected to the collar 4 and the damping bridge 6 is connected, through the arm 7, to the wall 3. The end 15 of the arm 7 is thus the base of the fastening device 1, in that it is the part connected to the wall 3.

FIG. 5 shows a damping bridge 106 according to a second embodiment. According to this embodiment, the membranes are not fixed on their entire periphery on the lateral structore. The main interest of this embodiment is to provide a facility in the single-piece (monopiece) molding mode fabrication, in a thermoplastic material for instance. According to this embodiment, the lateral wall 13 of the base 5 is not adjacent to the lateral structure 10 of the damping bridge 7, but the lateral wall of the base 5 can be found in the continuity of the lateral structure of the damping bridge 7. Thus, the lateral wall 13 and the lateral structure 10 form a single part (structure 110 formed by the lateral arms 113).

The damping bridge 106 includes a central arm 107, two membranes 108 and 109 and a structure 110.

The central arm 107 has a right cylinder shape, with an axis B, which passes through a hole 111 for attaching a collar or fastening to a wall. Alternatively, the central arm could present other geometries such as for example a cylindrical shape of a square or rectangular section. The membranes 108 and 109 are two rectangular flat plates parallel to each other, perpendicular to the axis B, centered and fixed on the axis B. The central arm 7 thus connects the center of the membrane 108 to the center of the membrane 109. The end 115 of the central arm 107 protrudes from the membrane 108. The structure 110 includes a bottom wall 112 and two lateral arms 113 on which the ends of the membranes 108 and 109 can be fixed. The bottom wall 112 is rectangular, parallel to the membranes 108 and 109, but is thicker and more rigid. It is crossed by a hole 114 for fixing it to the wall or fixing a collar. The lateral arms 113, of rectangular shape, extend from the bottom wall 112 parallel to the axis B, on both sides of the central arm 107. They connect the ends of the membranes 108 and 109 together.

In other words, the membranes 108 and 109 are connected by the structure 110, on both sides of the central arm 107 in a direction perpendicular to the axis B and parallel to the length of the membranes 108 and 109.

In a variant not shown, the two membranes have a different geometry, such as a different length or a different width. The structure that connects them thus has a suitable form.

Similarly to the damping bridge 6, the damping bridge 106 performs two functions. On the one hand, vibrations oriented parallel to the axis B and which will be forwarded to the supporting wall are absorbed by deformation of the membranes 108 and 109. On the other hand, the loads perpendicular to the axis B and parallel to the length of the membranes 108 and 109 are transmitted without substantial deformation.

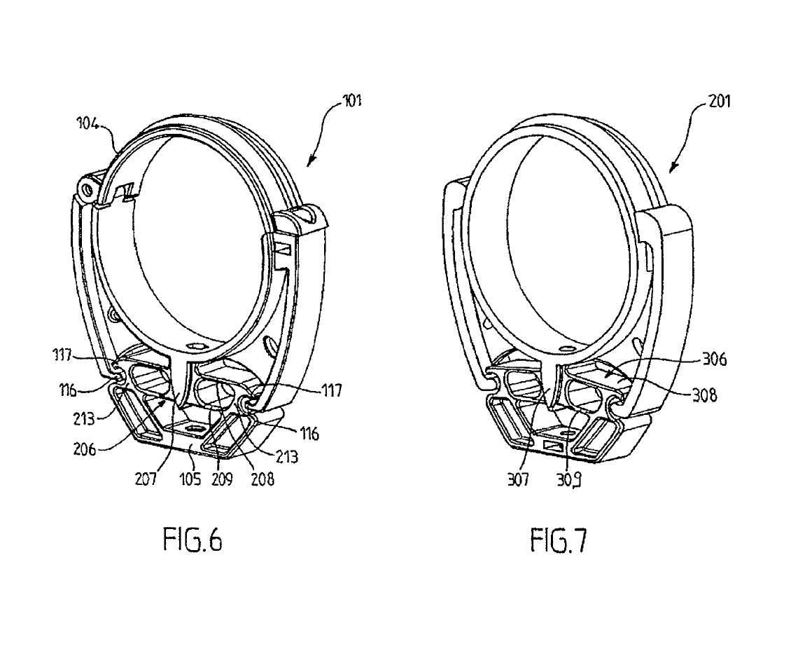

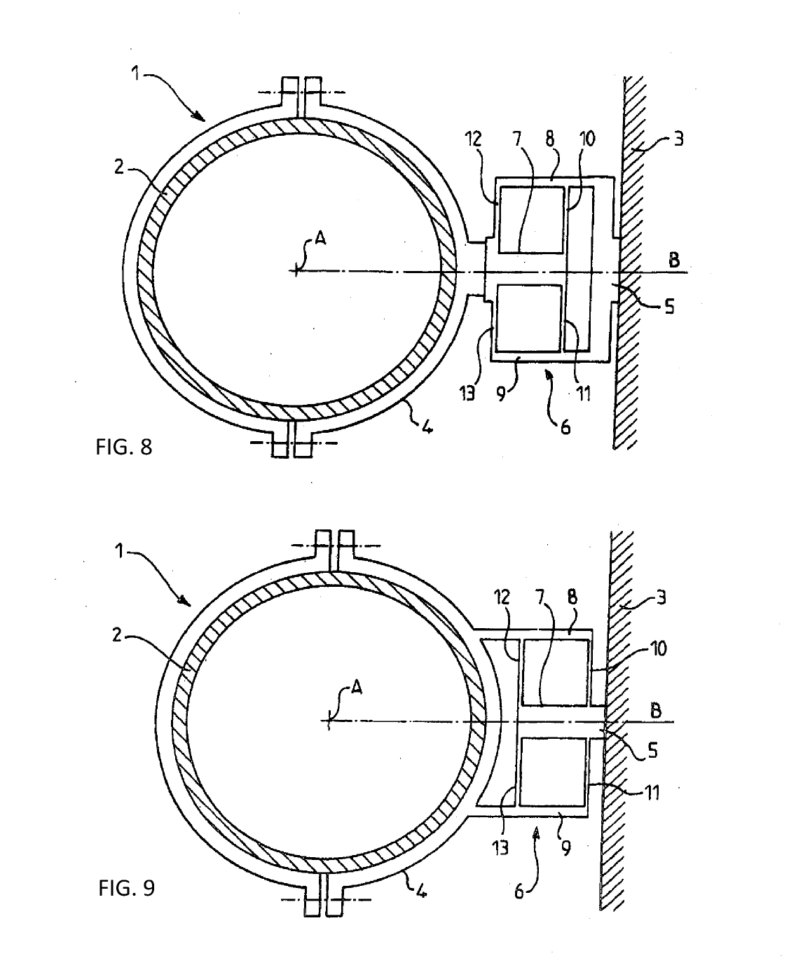

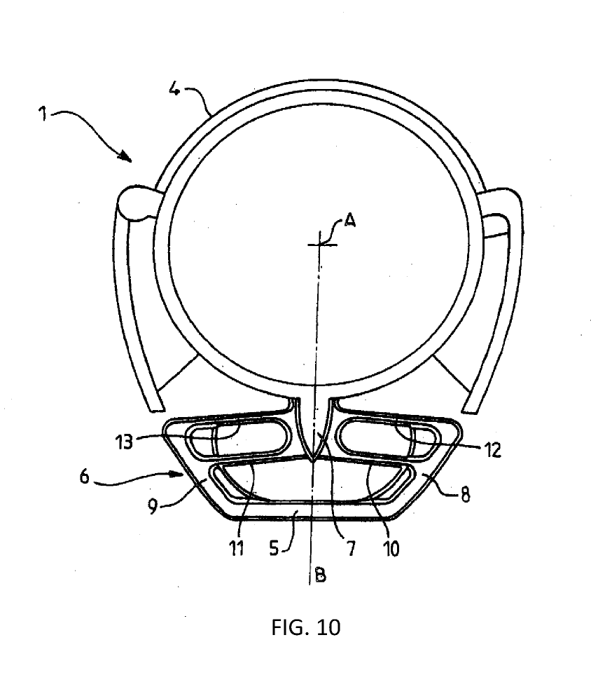

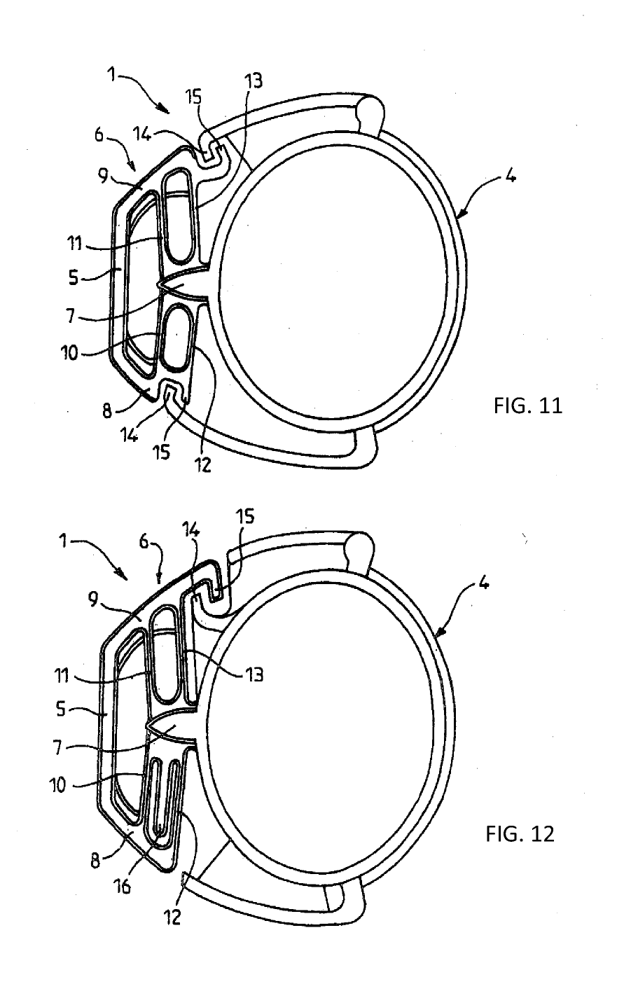

FIG. 6 shows a fastening device 101 which includes a damping bridge 206 produced by the same principle as the one of the damping bridge 106 of FIG. 5, that is to say, with two flat membranes 208 and 209 in parallel rectangular shapes. The fastening device 101 includes a collar 104 and a base 105 connected by the damping bridge 206. The damping bridge 206 includes a central arm 207, two membranes 208 and 209, which are fixed on the one hand on the central arm 207 and on the other hand on the lateral arms 213 and two lateral arms 213.

The fastening device 101 also includes two stops 116 connected to the collar 104, and two stops 117 located at the ends of lateral arms 213 of the damping bridge 206. As can be seen, the stops 116 and 117 are embodied by hooks. Alternatively, other shapes and positions could be used. The stops 116 and 117 can cooperate to prevent excessive displacements of wide amplitude of the central arm 207 remote from the base 105. This is particularly useful when the base 105 is fixed to the ceiling. Indeed, the weight exerted by the tube 2 can increase, for example in case of clogged pipes. The stops 116 and 117 then come into contact and prevent excessive deformation of the damping bridge 206.

In addition, an advantage of the fastening device 101 is that it can be made of a monopiece material, using molding, as can be inferred from the shape shown in FIG. 6.

FIG. 7 shows a fastening device 201 similar to the fastening device 101 in FIG. 6. It is not necessary to describe it in detail. It may be noted that the membranes 308 and 309 of the damping bridge 306 each form an angle slightly smaller than 180°, at the central arm 307. For example, the angle is between 175° and 180°. In other words, the membranes 308 and 309 are substantially parallel. This configuration has a lower damping compared to the one shown in FIG. 6. However, such a fastening device can be more easily manufactured by molding.

Although the invention has been described in conjunction with several specific embodiments, it is obvious that it is not limited and includes all technical equivalents of the described means and combinations thereof if they come within the scope of the invention.

For example, different parts of the bridge damping or mounting device could be made of different materials, for example according to their different features and characteristics. For example, the membranes could be made of a material less rigid than that of the structure or of thin metal sheets.

1. A damping bridge, for fixing a pipe to a wall and to attenuate the vibrations transmitted from said pipe to said wall, comprising two membranes designed to be arranged in a parallel manner to said wall and said pipe, a central arm extending perpendicularly to said membranes and connecting said membranes together at their center, and a structure having at least one lateral portion perpendicular to said membranes connecting said membranes together over at least a portion of the outer edge thereof,
characterized in that: said membranes are elastically deformable, and in that the structure and the central arm, also deformable, are more rigid than said membranes, such that the vibrations oriented perpendicularly to the wall and experienced by the central arm are transmitted, attenuated, to the structure, by deformation of the membranes,
and in that said membranes are substantially flat and substantially parallel to each other, distant from each other, such that the loads oriented parallel to the wall are transmitted without substantial deformation of the damping bridge and thus of the membranes.

2. A damping bridge according to the preceding claim, wherein said central arm and said structures are rigid.

3. A damping bridge according to the preceding claim, wherein said structure shows a cylindrical shape having a generatrix parallel to said arm and a directrix corresponding to an edge of one of said membranes.

4. A damping bridge according to the preceding claim, wherein said structure shows a cylindrical rotating shape, said arm showing a cylindrical rotating shape and being coaxial with said structure.

5. A damping bridge according to claim 1, wherein said structure includes two lateral arms forming the lateral portion perpendicular to said membranes, said lateral arms being located on each side of said arm said membranes having a plate shape extending from one of said lateral arms to the other.

6. A damping bridge according to claim 1, made of a single-material piece.

7. A damping bridge according to claim 1, wherein said membranes have a thickness smaller than said arm and said structure.

8. A fastening device comprising a collar for maintaining a pipe, a base for being fixed to a wall, and a damping bridge according to claim 1 connecting said collar to said base.

9. A fastening device according to claim 8, wherein said damping bridge, said base and at least part of said collar are made of a single-material piece.

10. A fastening device according to claim 8, including a first stop fixed to the collar and a second stop connected to the base, the first stop and the second stop being able to cooperate to prevent movement of the collar at distance from the base, with an amplitude greater than a given threshold.
